(19) United States
(12) Patent Application Publication
(10) Pub. No.: US 2025/0144998 A1
(43) Pub. Date: May 8, 2025

(54) All-Terrain Vehicle

(71) Applicant: Zhejiang CFMOTO Power Co., Ltd., Hangzhou (CN)

(72) Inventors: Fuying Cheng, Hangzhou (CN); Zhenxiang Kuang, Hangzhou (CN); Guangxuan Feng, Hangzhou (CN); Jiahui Hou, Hangzhou (CN); Jian Song, Hangzhou (CN); Jianwu Liang, Hangzhou (CN)

(21) Appl. No.: 19/003,411

(22) Filed: Dec. 27, 2024

Related U.S. Application Data
(63) Continuation of application No. PCT/CN2021/139951, filed on Dec. 19, 2022.

(30) Foreign Application Priority Data
Jun. 30, 2022 (CN) 202210781810.X

(51) Int. Cl. B60K 17/16; B60K 17/02; B60K 17/344; F16H 48/08; F16H 48/22; F16H 57/02; F16H 57/021; F16H 57/037

(52) U.S. Cl. CPC B60K 17/20; B60K 17/02; B60K 17/344; F16H 48/08; F16H 48/22; F16H 57/021; F16H 57/037; F16H 2057/02026; F16H 2057/02052

(57) ABSTRACT

A front differential includes an outer ring spline mounted on an inner housing for rotation with the ring gear joinder, an inner ring spline mounted on one of the semi-axle gears, and a plurality of friction members disposed between the inner ring and the outer ring. The friction members are interleaved plates which can create a partial friction state and a fully locked state of the front differential through application of axial pressure force. The spline mounting of the inner and outer rings allows axial movement so the axial pressure force application is more accurate despite manufacturing tolerances. A ball bearing is arranged between the differential housing and the ring gear joinder. The ball bearing is connected to the differential housing by a clearance fit which allows the ball bearing to move axially relative to the differential housing.

### RELATED APPLICATION INFORMATION

The present application is a continuation of and claims the benefits of priority to International Application Number PCT/CN2022/139951, entitled ALL-TERRAIN VEHICLE, filed on Dec. 19, 2022, and further claims priority to Chinese patent application filed on Jun. 30, 2022 with an application number of 202210781810.X and entitled “All-terrain Vehicle”, the contents both of which are incorporated herein in their entirety by reference.

### FIELD OF THE DISCLOSURE

The present application relates to the technical field of vehicles, in particular to all-terrain vehicles.

BACKGROUND OF THE DISCLOSURE

When a wheeled vehicle is traveling around a corner, the distances traveled by the inner and outer wheels at the same time are different, thereby leading to a rotational speed difference between the inner and the outer wheels. In order that the inner and outer wheels can rotate at different rotational speeds when traveling around a curve, a differential needs to be arranged in a drive train of the vehicle. However, all-terrain vehicles frequently travel over poor road conditions muddy and slippery trails, and a differential can seriously affect the ability of the all-terrain vehicle to pass through. For example, when one of the all-terrain vehicle wheels is deeply sunk in the mud or is hanging in the air, although the other wheel has good traction, the all-terrain vehicle can get stuck. The wheel in the mud can have little or no traction with the ground, allowing it to spin without getting a driving force because of the function of a differential. Therefore, all-terrain vehicle differentials frequently have gears that are fully lockable through a locking mechanism, such that the differential loses its differential function, and more torque is transferred to the wheel that has traction, giving the all-terrain vehicle enhanced ability to get unstuck.

Some fully lockable differentials have a risk of deformation. Other fully lockable differentials have a high manufacturing cost. Better solutions are needed.in

### SUMMARY OF THE INVENTION

The present invention involves use a differential design particularly suited for use in an all-terrain vehicle, and an all-terrain vehicle using such a differential. The all-terrain vehicle includes a pair of front wheels and a pair of rear wheels, and a prime mover assembly for providing torque to move the vehicle. A drive train with a drive shaft and a front differential delivers torque from the prime mover assembly to the wheels. The front differential has an input bevel gear driven by the drive shaft. A ring gear joinder having a ring gear and an inner housing fixedly connected to the ring gear is meshed with the input bevel gear so the ring gear joinder rotates about a differential transverse axis. The inner housing supports at least one planetary gear shaft, and at least one planetary gear is rotationally supported by the planetary gear shaft. Right and left semi-axle gears for driving the front wheels are meshed with the at least one planetary gear for rotation about the differential transverse axis.

In one aspect, the front differential further includes a first ring supported for rotation with the ring gear joinder, a second ring supported for rotation with one of the semi-axle gears, and a plurality of friction members disposed between the first ring and the second ring. At least one of the friction members rotates with the first ring and at least one of the friction members rotates with the second ring. At least one, and more preferably both of the first ring and the second ring are mounted in a way that allows axial movement relative to the ring gear joinder. For instance, the preferred embodiment includes an outer ring spline mounted on the inner housing, an inner ring spline mounted on one of the semi-axle gears, and the friction members as interleaved friction plates disposed between the inner ring and the outer ring. Some of the interleaved friction plates rotate with the inner ring, and some of the interleaved friction plates rotate with the outer ring.

A differential housing covers at least a portion of the front differential. In another aspect, a ball bearing is arranged between the differential housing and the ring gear joinder for rotationally supporting the ring gear joinder relative to the differential housing. The ball bearing is connected to the differential housing by a clearance fit which allows the ball bearing to move axially relative to the differential housing.

In another aspect, the planetary gear shaft is secured to the inner housing by a connection pin extending through a connection pin hole in the inner housing and through the planetary gear shaft. The connection pin is loosely fitted in its hole, but is held in place by joining the ring gear to the inner housing.

It should be understood that the above general description and the followed detailed description are merely illustrative and do not limit the present invention.

### BRIEF DESCRIPTION OF THE DRAWINGS

FIG. 1 is a front left perspective view of an all-terrain vehicle a preferred embodiment of the present invention.

FIG. 2 is a left perspective view of a prime mover assembly, drive train and wheels for use in the all-terrain vehicle of FIG. 1;

FIG. 3 is a rear right perspective view of the front differential assembly of FIG. 2;

FIG. 4 is a rear left exploded perspective view of many of the components of the front differential assembly of FIGS. 2 and 3;

FIG. 5 is an enlarge perspective view of the outer ring of the clutch of the front differential assembly of FIGS. 2-4;

FIG. 6 is a cross-sectional plan view of the front differential assembly of FIGS. 2 and 3;

FIG. 7 is a cross-sectional plan view of the drive shaft transfer case and the input bevel gear of the front differential assembly of FIGS. 2, 3 and 6, with the drive shaft transfer case transferring torque;

FIG. 8 is the cross-sectional plan view of the drive shaft transfer case of FIG. 7, with the drive shaft transfer case not transferring torque;

FIG. 9 is an enlargement of front portions of the cross-sectional plan view of FIG. 6;

FIG. 10 is an enlargement centered on the left ball bearing of the cross-sectional plan view of FIGS. 6 and 9;

FIG. 11 is an enlargement of the circular portion 11 of FIG. 6, with the front differential in the fully unlocked position;

FIG. 12 is an enlargement similar to FIG. 11, but with the front differential in the fully locked position and with the cross-sectional cut taken through the new position of the ball; and

FIG. 13 is a cross-sectional rear view of the front differential of FIGS. 2, 3 and 6, taken at cut lines 13-13 of FIG. 6 along the differential transverse axis, but not showing cross-hatching so lead lines are more clearly visible;

The accompanying drawings herein are incorporated into the specification and form a part of the specification, illustrating preferred embodiments conforming to the present invention. The drawings and detailed description text are to be used in combination to explain and provide examples of the principles of the present invention.

### DETAILED DESCRIPTION

In order to better understand technical solutions of the present invention, certain embodiments are described in detail below in combination with the accompanying drawings.

It should be clear that the described embodiments are merely a part but not all of the embodiments of the present invention. Based on the embodiments described in detail, all other embodiments obtainable by those skilled in the art without creative effort shall fall within the protection scope of the present invention.

The singular forms of “a” and “the” may encompass plural forms, unless the context clearly indicates otherwise. It should be understood that the term “and/or” as used herein is merely for describing an association relationship of the associated objects, indicating that three kinds of relationships may exist, e.g., A and/or B, which may be expressed as: A exists alone, both A and B exist, and B exists alone. In addition, the character “/” in this text generally indicates that the associated objects before and after are of an “or” relationship.

It should be noted that the positional terms such as “upper”, “lower”, “left”, “right” used in describing the preferred embodiments are from the perspective shown in the accompanying drawings and should not be construed as limiting the present invention. Furthermore, when referring to an element being connected to or contacting another element, it should be understood within context that such connection or contact may be direct or indirect through one or more intermediate elements.

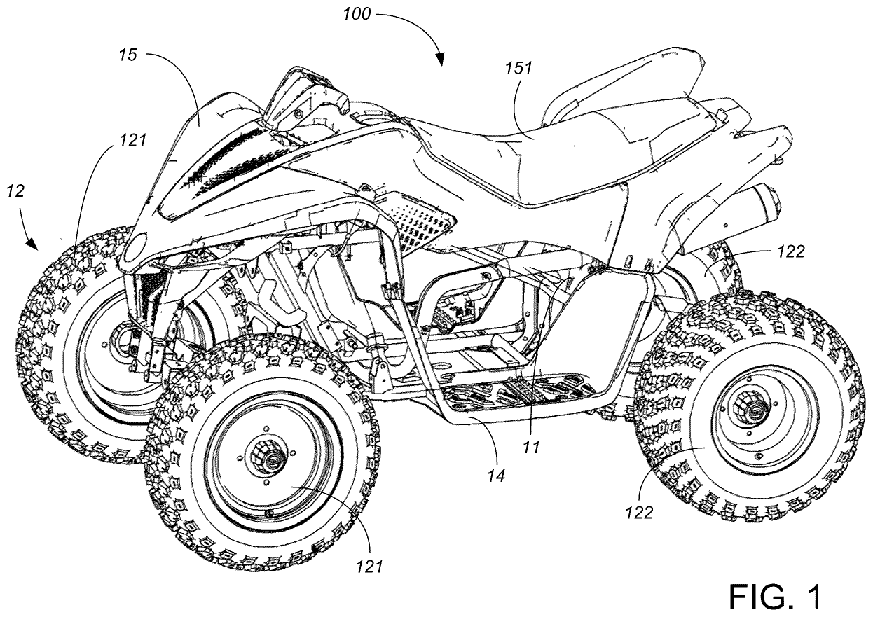

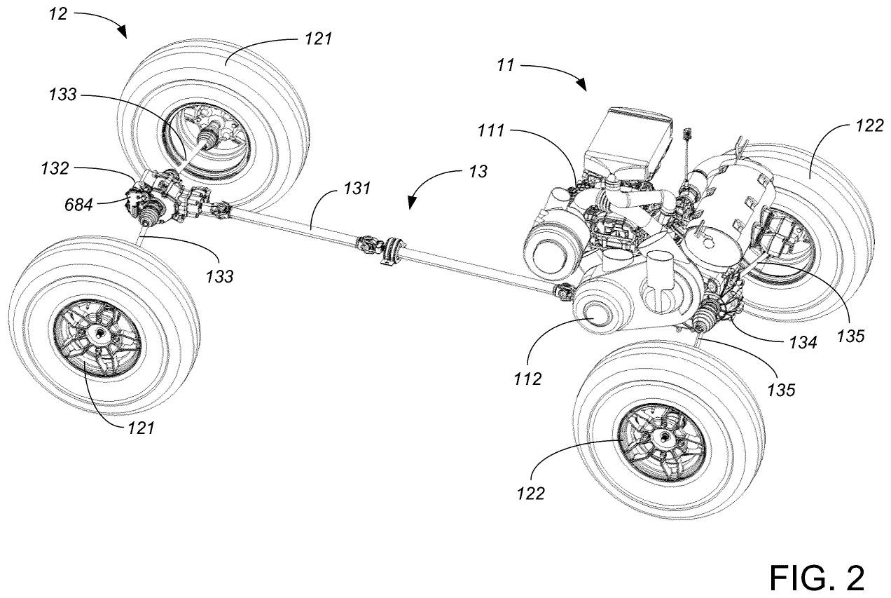

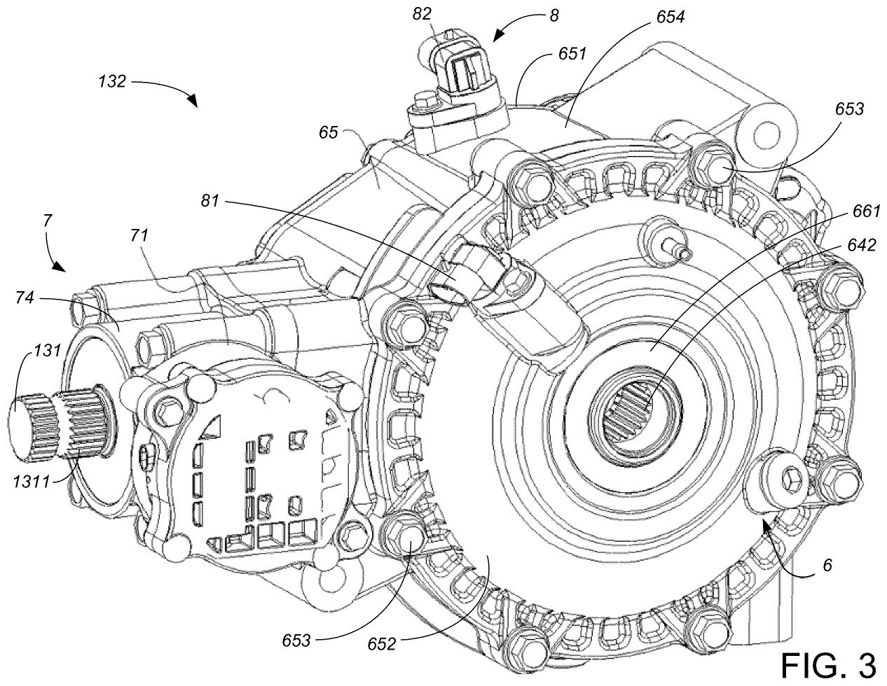

Referring to FIGS. 1 and 2, an all-terrain vehicle 100 in accordance with the present invention includes a prime mover assembly 11, four wheels 12, and a drive train 13. The prime mover assembly 11 may include an internal combustion engine 111 and/or an electric motor (not shown) providing power for locomotion of the all-terrain vehicle 100 through a continuously variable transmission or CVT 112. The drive train 13 transmits torque from the prime mover assembly 11 to the wheels 12. The drive train 13 includes a drive shaft 131 connected to the prime mover assembly 11, a front differential assembly 132, two front half shafts 133, a rear differential assembly 134 and two rear half shafts 135. The four wheels 12 include a pair of front wheels 121 and a pair of rear wheels 122. The front differential assembly 132 transmits torque from the drive shaft 131 to the front half shafts 133, which in turn drive the pair of front wheels 121. The rear differential assembly 134 transmits torque to the rear half shafts 135, which in turn drive the pair of rear wheels 122.

The all-terrain vehicle 100 further includes a frame 14 and a body cover 15. The frame 14 serves as a skeleton for carrying and connecting various components on the all-terrain vehicle 100 and for bearing various loads coming from the inside and outside of the vehicle 100. The body cover 15 is at least partially connected to the frame 14, and preferably includes a straddle seat 151. The prime mover assembly 11 is mounted to the frame 14, and the drive train 13 is supported by the frame 14 and/or wheels 12.

The all-terrain vehicle 100 adapts to different road, off-road and trail conditions in part by allowing user-controlled switching between two-wheel (preferably rear-wheel) drive and four-wheel drive. For instance, the preferred front differential assembly 132 includes a front differential 6 and a drive shaft transfer case 7. The drive shaft transfer case 7 is used to control whether torque from the drive shaft 131 reaches the front differential 6. By including the drive shaft transfer case 7 as part of the front differential assembly 132, there is no need to include a transfer case as part of the prime mover assembly 11, allowing the prime mover assembly 11 to be smaller and mounted lower in the vehicle 100. Including the drive shaft transfer case 7 as part of the front differential assembly 132 also provides a good location for access and maintenance work on the drive shaft transfer case 7.

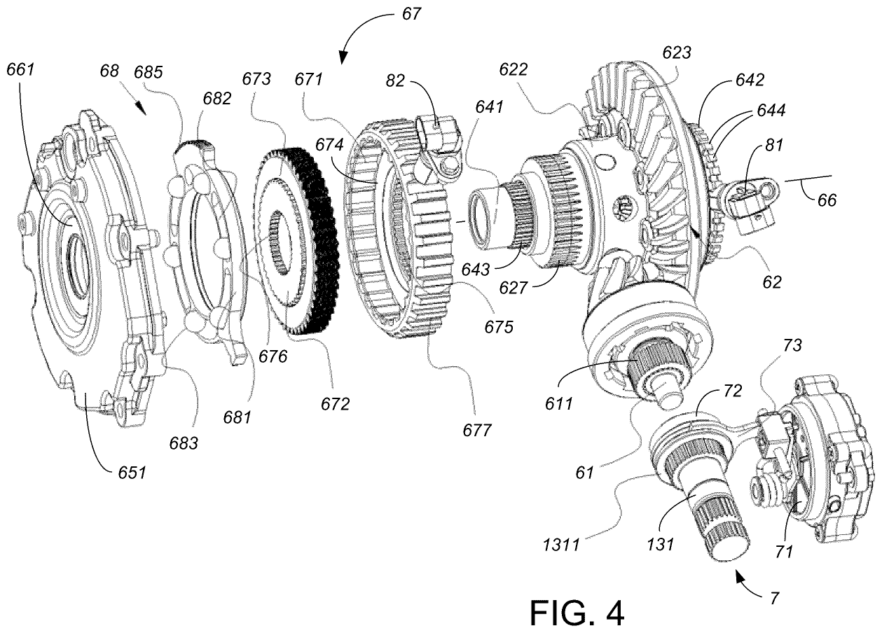

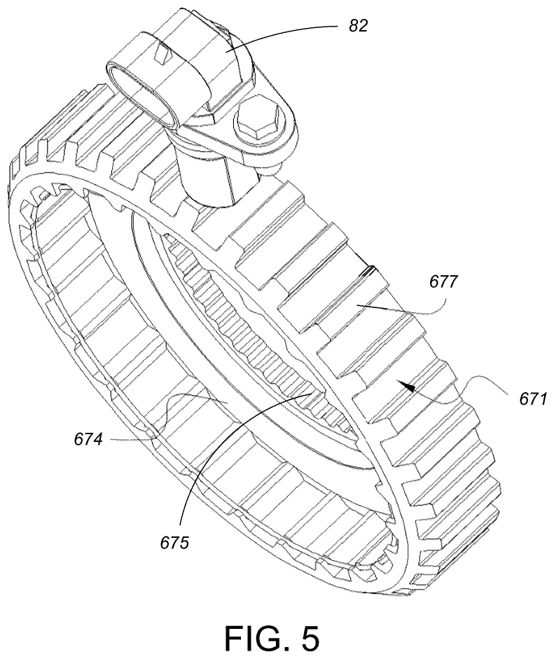

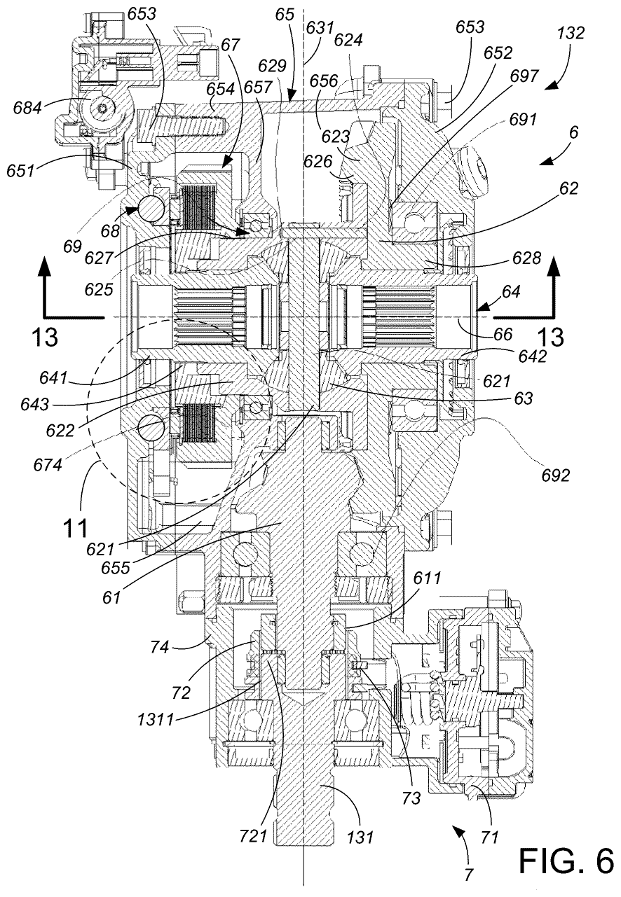

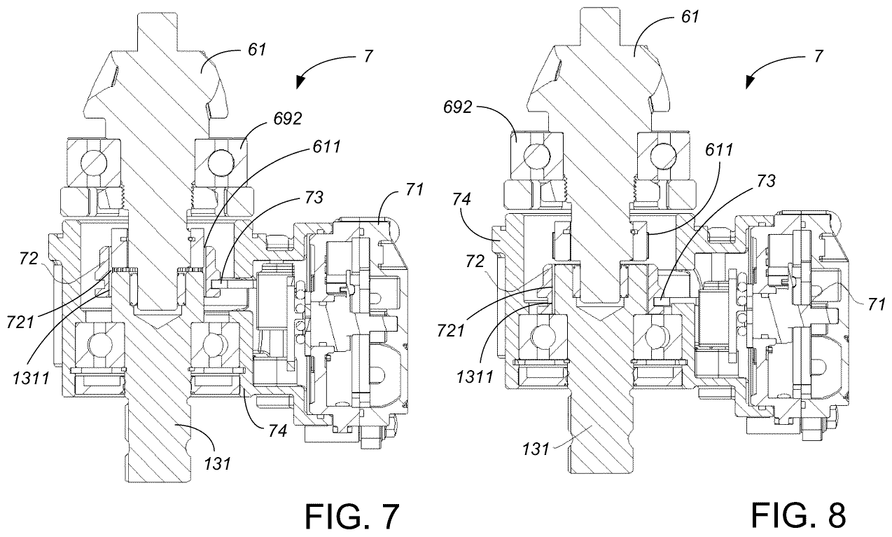

The preferred drive shaft transfer case 7 is constructed similar to the actuator for differential mode shift of U.S. Pat. Nos. 11,346,433, 11,353,099, 11,525,500 and 11,674,580, all incorporated by reference. Specifically, the drive shaft transfer case 7 includes an actuator 71 used to move a spline sleeve 72 in an axial direction via an actuator shifting fork 73 as best shown in FIGS. 4 and 6. The actuator 71 can drive the spline sleeve 72 to axially move between an engaged position and a disengaged position.

When the spline sleeve 72 is located in the engaged position, the axial position of the spline sleeve 72 causes internal splines 721 on the spline sleeve 72 to mesh with both external splines 611 on an input bevel gear 61 of the front differential 6 and external splines 1311 on an end of the drive shaft 131. When the spline sleeve 72 is located in the disengaged position, its axial position unmeshes the spline sleeve 72 with at least one of the input bevel gear 61 and the drive shaft 131, so rotation of the drive shaft 131 does not turn the input bevel gear 61 and no torque reaches the front differential 6 or the front wheels 121. The drive shaft transfer case 7 includes a transfer case housing 74 that rotationally supports the spline sleeve 72 and/or the end of the drive shaft 131.

The front differential 6 generally includes the input bevel gear 61, a ring gear joinder 62, one or more pinion or planetary gears 63, and two semi-axle gears 64 including a left semi-axle gear 641 and a right semi-axle gear 642, all supported within a housing 65. The front differential 6 largely operates as generally known and understood in the differential art, such as in the differential of U.S. Pat. No. 10,816,071, incorporated by reference. Specifically, the ring gear joinder 62 and the semi-axle gears 64 rotate about a differential transverse axis 66. The left and right semi-axle gears 641, 642 each drive the respective left and right front wheels 121 through the respective left and right front half shafts 133. The preferred front differential 6 includes four planetary gears 63, but a different number of planetary gears can alternatively be used. The planetary gears 63 are each rotationally mounted (for rotation when providing differential function about one or more planetary gear axes 631 which are perpendicular to the differential transverse axis 66) on a planetary gear shaft 621, and the planetary gear shafts 621 are fixed relative to an inner housing 622 of the ring gear joinder 62 (so the collection of planetary gears 63 also rotate about the differential transverse axis 66 with the ring gear joinder 62). All of the planetary gears 63 are in meshed engagement with both of the two semi-axle gears 64. The left semi-axle gear 641 extends coaxially through the inner housing 622 of the ring gear joinder 62, while the right semi-axle gear 641 extends coaxially through a ring gear 623 of the ring gear joinder 62.

In the preferred embodiment, two planetary gear shafts 621 intersect, with one of the planetary gear shafts 621 inserted through a hole in the other planetary gear shaft 621. In the preferred embodiment, the planetary gear shafts 621 are both secured to the inner housing 622 of the ring gear joinder 62 using at least one connecting pin 624. The connecting pin 624 preferably extends through the inserted one of the two planetary gear shafts 621, with the connecting pin 624 preferably being aligned parallel with the differential transverse axis 66. During manufacture of the inner housing 622, a connecting pin hole 625 for the inserted one of the planetary gear shafts 621 is formed in the inner housing 622, sized slightly larger than the connecting pin 624, such that the/each connecting pin 624 fits loosely into its connecting pin hole 625 of the inner housing 622. The inner housing 622 has an outer diameter which mates tightly into a shoulder 626 of the ring gear 623 as best shown in FIG. 6. Assembly of the front differential 6 involves first assembling the left semi-axle gear 641 into the inner housing 622, then assembling the planetary gears 63 on their shafts 621 into the inner housing 622 with one of the shafts 621 extending through the other, then inserting the connecting pin 624 in its connecting pin hole 625 so as to hold the planetary gear shafts 621 in place, then assembling the right semi-axle gear 642 relative to the planetary gears 63, and finally sandwiching these components together by press fitting or otherwise fixing the ring gear 623 onto the outer diameter of the inner housing 622. The press fitting of the ring gear 623 onto the outer diameter of the inner housing 622 simultaneously encloses the connecting pin 624 so it cannot fall out of the connecting pin hole 625 of the inner housing 622, i.e., it is the press fitting or otherwise joining of the ring gear 623 and the inner housing 622 together which fixes the connecting pin 624 into place. This structure and assembly method avoids the use of any other connecting parts to fix the connecting pin 624 into the connecting pin hole 625 and to fix both planetary gear shafts 621 relative to the inner housing 622, reducing the number of parts and reducing assembly, disassembly and maintenance difficulty and costs.

The differential housing 65 of the front differential 6 supports the input bevel gear 61 as well as the assembled ring gear joinder 62 (with planetary gears 63 and two semi-axle gears 64 rotationally supported therein). The preferred differential housing 65 includes a left sidewall 651 and a right sidewall 652 joined such as by bolts 653 to a circumferential wall 654. The diameter of the circumferential wall 654 is preferably in the range from 150 mm to 220 mm, more preferably in the range from 60 mm to 200 mm, and most preferably in the range from 60 mm to 180 mm. The transfer case housing 74 is preferably connected to the differential housing 65, such as to a rear side of the circumferential wall 654. In some embodiments (not shown), the transfer case housing is provided as two shell halves integrally formed with the left and right sidewalls of the differential housing for ease of manufacture and assembly.

The front differential 6 has a fully unlocked state in which the planetary gears 63 can freely rotate, each about its own planetary gear axis 631, relative to the ring gear joinder 62. The meshing of the planetary gears 63 with the semi-axle gears 64 is such that rotation of the planetary gears 63 allows the left semi-axle gear 641 and the right semi-axle gear 642 to rotate at different rotational speeds about the differential transverse axis 66, one faster and one slower but such that the average rotational speed of the two semi-axle gears 64 matches the rotational speed of the ring gear joinder 62. As with any differential, the fully unlocked state of the front differential 6 allows the right and left front wheels 121 to turn at different speeds when cornering, so both front wheels 121 can maintain frictional contact with the ground/pavement despite the fact that the outside front wheel 121 when cornering travels a greater distance (and rotates more) than the inside front wheel 121 when cornering (with the right/left direction of cornering determining which right/left front wheel 121 is “inside” and which is “outside”).

Unlike common differentials, the preferred front differential 6 also has at least one partial frictional state, where the left semi-axle gear 641 and the right semi-axle gear 642 can rotate at different rotational speeds but the front differential 6 applies a frictional force tending to minimize the rotational speed difference. Preferably the partial frictional state can be entered from the fully unlocked state without stopping the vehicle 100 and without stopping the drive shaft 131. The preferred front differential 6 also has a fully locked state in which the planetary gears 63 are stationary relative to the ring gear joinder 62 and the semi-axle gears 64, causing the ring gear joinder 62 and the semi-axle gears 64 to rotate synchronously about the differential transverse axis 66 (with no rotation of the planetary gears 63 about their planetary gear axes 631).

The front differential 6 includes at least one friction transfer mechanism. The preferred friction transfer mechanism includes a normally-disengaged clutch 67 having an outer ring 671, an inner ring 672, and a plurality of interleaved friction plates 673. The preferred outer ring 671 includes an annular wall 674 defining an assembly cavity for the interleaved friction plates 673.

As best understood with reference to FIG. 4, the outer ring 671 is rotationally fixed relative to the ring gear joinder 62 such as in the preferred embodiment by having interior splines 675 which mate with exterior splines 627 on the inner housing 622 of the ring gear joinder 62. The inner ring 672 is rotationally fixed relative to the one of the semi-axle gears 64, such as in the preferred embodiment by having interior splines 676 which mate with exterior splines 643 on the left semi-axle gear 641. An alternative embodiment reverses the left-right orientation of the front differential 6. The interleaved friction plates 673 include one or more friction plates which are toothed to rotate with the inner ring 672 alternating between one or more friction plates which are toothed to rotate with the outer ring 671. However, the splined connection between the outer ring 671 and the inner housing 622 of the ring gear joinder 62 allows some axial movement of the outer ring 671 relative to the ring gear joinder 62. Similarly, the splined connection between the inner ring 672 and the left semi-axle gear 641 allows some axial movement of the inner ring 672 relative to the left semi-axle gear 641. The axial movement permitted by at least one and more preferably both of these splined connections is important toward establishing the proper friction interface between the interleaved friction plates 673. Because of the axial movement provided by these splined connections, lateral tolerances on manufacture and assembly of the left semi-axle gear 641, the ring gear joinder 62 and the differential housing 65 do not critically affect performance of the clutch 67. Because of the axial movement provided by these splined connections, thermal expansion and/or contraction similarly does not critically affect performance of the clutch 67.

The clutch 67 is normally disengaged, with spacing between the interleaved friction plates 673 sufficient that there is no transfer of torque between the outer ring 671 and the inner ring 672, leaving the front differential 6 in the fully unlocked state. However, the clutch 67 can be partially engaged by reducing the axial spacing of the interleaved friction plates 673 (at which point the clutch 67 can be thought of as “slipping”), causing some transfer of torque between the outer ring 671 and the inner ring 672 but still allowing different rotational speeds between the outer ring 671 and the inner ring 672. The slipping clutch 67 provides the partial frictional state(s) of the front differential 6. The clutch 67 can also be fully engaged by reducing spacing/increasing pressure of the interleaved friction plates 673 sufficiently that there is no slippage, thereby fixing the outer ring 671 and the inner ring 672 to rotate about the transverse differential axis 66 together at the same rotational speed. In the preferred embodiment, the fully engaged clutch 67 creates the fully locked state of the front differential 6 with no further locking mechanism.

In one embodiment, engagement of the clutch 67 is accomplished electrically with a solenoid (not shown) directly providing an axial pressure force on the interleaved friction plates 673. The rotational speeds of two of the left semi-axle gear 641, the ring gear joinder 62 and the right semi-axle gear 642 are sensed as further discussed below (and/or the rotational speeds of the left and right front wheels 121, or left and right half shafts 133 are sensed), and a controller (not shown) analyzes rotational speed differences to determine how much axial force to place on the interleaved friction plates 673 and thereby control the degree to which the front differential 6 is locked. If desired, the controller may also use steering angle as part of its assessment. For instance, consider a situation where the vehicle 100 is being steered straight forward, but is stuck with one of its front wheels 121 suspended in the air (because the undulating surface the vehicle 100 is being driven over exceeds the vehicle's suspension travel) or sliding in mud. With an ordinary unlocked differential, the airbourne/mud-sliding wheel might take all the torque of the drive shaft 131 and rotate at twice the rotational speed of the ring gear joinder 62, with the stuck wheel taking none of the torque of the drive shaft 131 and not rotating at all. The controller determines that the airbourne/mud-sliding wheel is spinning much faster than the stuck wheel despite having no turn angle, and energizes the solenoid to increase axial pressure on the interleaved friction plates 673. The tightening of the interleaved friction plates 673 frictionally transfers torque between the ring gear joinder 62 and the left semi-axle gear 641, biasing toward having the ring gear joinder 62 and the left semi-axle gear 641 rotate at the same rotational speed and delivering increasingly more torque to the stuck wheel and less torque to the airbourne/mud-sliding wheel, until reaching a fully locked compression of the interleaved friction plates 673 where both wheels are forced to rotate at the same rotational speed.

In one preferred embodiment, engagement of the clutch 67 is accomplished mechanically with a clutch engagement apparatus 68. The clutch engagement apparatus 68 includes a tray 681 providing ramped raceways 682 for a plurality of balls 683 allowing the balls 683 to roll therein. Along a circumferential direction of the tray 681, the depth of the depression of the ramp raceway 682 for each ball 683 (with depth measured along the direction of the differential transverse axis 66) increases gradually from small to large. The preferred embodiment uses six balls 683 in rolling contact with the left sidewall 651 of the differential housing 65. A solenoid 684 (shown only in FIGS. 2, 6 and 13) or motor is used against a peripheral extension 685 (shown only in FIG. 4) of the tray 681 to rotate the tray 681 up to about 100° about the differential transverse axis 66. As rotation of the ramp raceways 682 increases, the balls 683 each roll from a region with a large depression depth to a region with a small depression depth on their ramp raceways 682, such that the position of the tray 681 shifts rightwardly toward the clutch 67, so as to push the tray 681 to press against the interleaved friction plates 673. If desired, a spring (not shown) can be added to automatically reset, returning the tray 681 and its ramp raceways 682 to the fully unlocked position whenever the solenoid 684 is not energized.

Note in this embodiment of FIGS. 4 and 6 that the tray 681, when not being rotated to change the clutch friction force, remains stationary relative to the differential housing 65 while the ring gear joinder 62, the clutch 67 and the left semi-axle gear 641 are rotating to deliver torque to the left front wheel 121. An annular slide bearing 686 is positioned at the interface between the tray 681 and the interleaved friction plates 673 to minimize friction at this interface during delivery of the axial force from the tray 681 to the interleaved friction plates 673.

Another embodiment (not shown) attaches the tray and its ramp raceways for rotation with one of the ring gear joinder 62 or the left semi-axle gear 641, with the balls rolling on the other of the ring gear joinder 62 or left semi-axle gear 641 whenever there is differential function. As any rotational speed difference between the ring gear joinder 62 and the left semi-axle gear 641 increases, the balls each roll/slide from a region with a large depression depth to a region with a small depression depth on the ramp raceway according to the rolling inertia of the balls, such that that the position of the tray shifts rightwardly toward the clutch 67, so as to push the tray to press against the interleaved friction plates 673. As long as more torque is being delivered to one of the front wheels 121 than the other front wheel 121, the balls will bind to provide axial force to the interleaved friction plates 673. When torque equalizes between the front wheels 121 for several rotations, the balls each gradually roll/slide back from the region with a small depression depth to the region with a large depression depth with decreasing axial force being transmitted by the balls. The degree of locking of the front differential 6 thus increases with the rotational speed difference between the ring gear joinder 62 and the left semi-axle gear 641, that is, with the rotational speed difference and/or torque difference between the left and right front wheels 121. Attaching the tray for rotation with one of the ring gear joinder 62 or the left semi-axle gear 641 significantly reduces the need for the annular slide bearing 686, as well as the need for sensing rotation speed.

The inner ring 672 and the outer ring 671 are each sized so as to not significantly change the size of the front differential 6 while still providing adequate space for the interleaved friction plates 673. A ratio of the inner diameter of the outer ring 671 to the outer diameter of the inner ring 672 is preferably in the range from 1.2 to 1.8, more preferably in the range from 1.4 to 1.6, and most preferably in the range from 1.4 to 1.5. The inner diameter of the outer ring 671 is preferably in the range from 95 mm to 145 mm, and more preferably in the range from 110 mm to 130 mm. The outer diameter of the inner ring 672 is preferably in the range from 60 mm to 90 mm, and more preferably in the range from 70 mm to 80 mm. The friction plates 673 are tightly interleaved in the gap between the inner ring 672 and the outer ring 671, allowing the left semi-axle gear 641 to be narrow in width, reducing the width of the front differential 6, while still ensuring the strength of the inner ring 672 and the outer ring 671 and optimizing the inner and outer diameters and thicknesses of the friction plates 673. The number of interleaved friction plates being used can be selected as necessary for torque transmission ranging from no torque (fully unlocked differential) to full engine torque (fully locked differential) of the vehicle 100. In general, larger diameters and larger differences in diameter between the inner diameter of the outer ring 671 and the outer diameter of the inner ring 672 can permit use of fewer interleaved friction plates 673 to generate the desired frictional interaction between the ring gear joinder 62 and the left semi-axle gear 641.

The circumferential wall 654 of the preferred differential housing 65 defines a clutch accommodation chamber 655 separated from a ring gear accommodation chamber 656 by a midwall 657. The midwall 657 extends inwardly from the circumferential wall 654. The clutch 67 is arranged within the clutch accommodation chamber 655, as is at least a portion of the left semi-axle gear 641 and preferably a portion of the inner housing 622. The ring gear 623 is substantially arranged within the ring gear accommodation chamber 656 as is at least a portion of the right semi-axle gear 642. Using the midwall 657 to separate the clutch accommodation chamber 655 from the ring gear accommodation chamber 656 allows maintenance of both the clutch 67 and the ring gear joinder 62 without interference from the other. Meanwhile, in the assembly process, parts in the clutch accommodation chamber 655 and the ring gear accommodation chamber 656 can be assembled from each side respectively, thereby reducing the assembly tolerance and improving the precision of coordination between parts.

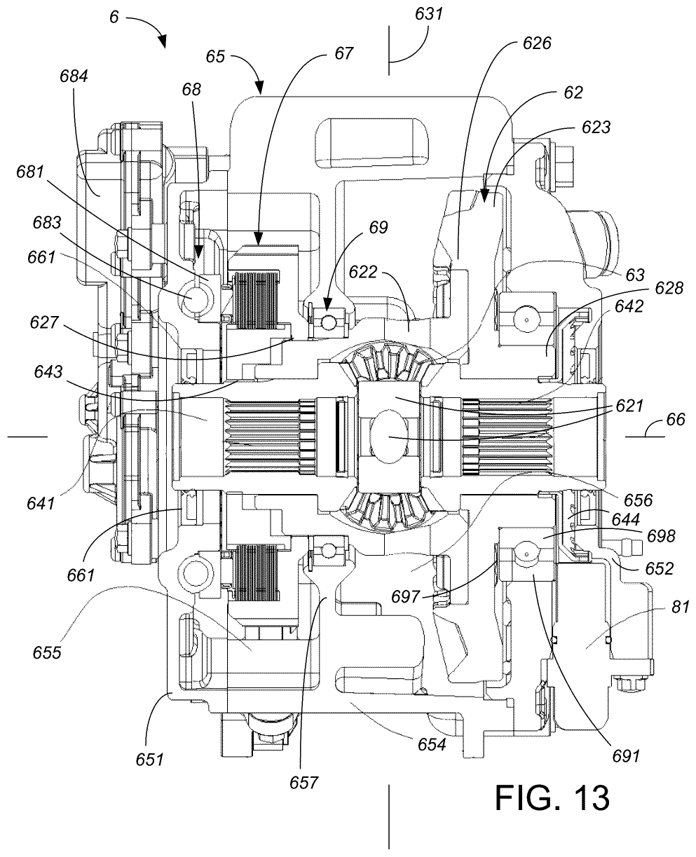

A left ball bearing 69 is preferably positioned at an inner end of the midwall 657 around the inner housing 622, while a right ball bearing 691 (shown only in FIGS. 6 and 13) is preferably positioned within the right sidewall 652 about an axially extending portion 628 of the ring gear 623. An input shaft ball bearing 692 is preferably positioned at a rear end of the circumferential wall 654. The left ball bearing 69 is thus closer to the planetary gear axis 631 (and the axis of the input bevel gear 61) than the right ball bearing 691. Arranging the left ball bearing 69 in the middle of the circumferential wall 654 in the right-to-left direction is conducive to the arrangement of the clutch 67, supporting the internal components of the front differential 6 with good stress and within a compact structure. The left ball bearing 69, the right ball bearing 691 and the input shaft ball bearing 692 cooperate to jointly support the moving components of the front differential 6. The two semi-axle gears 64 preferably mate in a sliding, sleeved relationship relative to the inner housing 622 and the ring gear 623, with the inner housing 622 and ring gear 623 acting as sliding bearings, so no additional ball bearings are required for rotational mounting of the semi-axle gears 64. Alternatively, separate ball bearings (not shown) could be provided for the semi-axle gears 64.

The left ball bearing 69 includes an inner race 693 and an outer race 694. The inner race 693 is sleeved on and mates around the inner housing 622, while the outer race 694 fits into a circular opening defined by the midwall 657. After assembly, the left ball bearing 69 is held in place such as with a retaining clip 658. Some part of the clutch 67 presses against either the outer race 694 or more preferably the inner race 693 to establish the axial position of the clutch 67 and to withstand the axial force placed on the friction plates 673. In the preferred embodiment shown, the annular wall 674 of the outer ring 671 presses against the inner race 693 of the left ball bearing 69.

The axial position of the left ball bearing 69 is not fixed by contact with a shoulder of either the midwall 657 or the inner housing 622. Instead as best shown in FIG. 10, the preferred embodiment uses an inner compressible gasket 695 positioned between the inner race 693 and a shoulder 629 of the inner housing 622, an outer compressible gasket 696 positioned between the annular wall 674 of the outer ring 671 and the inner race 693, and a clearance of the outer race 694 relative to the axial distance between a shoulder 659 of the midwall 657 and the retaining clip 658. This arrangement provides axial play of the left ball bearing 69 a) relative to the axial position of the midwall 657 and the rest of the differential housing 65; b) relative to the axial position of the inner housing 622; and c) relative to the axial position of the clutch 67. The axial play of the left ball bearing 69 allows the location of the force used to engage the clutch 67 to be divorced from a) manufacturing or assembly tolerances in the axial direction on the differential housing 65; b) manufacturing or assembly tolerances in the axial direction on the inner housing 622 and ring gear 623; and c) manufacturing or assembly tolerances in the axial direction on the clutch 67.

The clearance between the outer race 694 of the left ball bearing 69 relative to the gap between the retaining clip 658 and the shoulder 659 of the midwall 657 is a bearing clearance distance of W1+W2 in FIG. 10, i.e., the left ball bearing 69 can axially move, in the width direction of the all-terrain vehicle 100, by a bearing clearance distance of W1+W2 relative to the differential housing 65. The axial play of the left ball bearing 69, together with the splined connections of the clutch 67, allow the front differential 6 components to be more tightly fitted despite manufacturing and assembling tolerances. The bearing clearance distance W1+W2 is preferably in the range from 0.5 mm to 3 mm, more preferably in the range from 0.5 mm to 2 mm, and most preferably in the range from 1 mm to 1.5 mm. The tight fitting of the preferred front differential components provided by the bearing clearance distance W1+W2 reduces abrasions caused by shaking during operation of the front differential 6, prolonging the service life of the front differential 6 and particularly prolonging the service life of the clutch 67. At the same time, too large of a bearing clearance distance W1+W2 unnecessarily increases the width of the front differential 6.

While the bearing clearance distance W1+W2 reduces the criticality of tolerances in the axial direction, tolerances in the radial direction (such as between the outer diameter of the outer race 694 and the inner diameter of the opening through the midwall 657) still need to be fairly tight (such as a radial clearance maintained in the range from 0 mm to 0.1 mm, and more preferably in the range from 0 mm to 0.04 mm). Such a small, tightly toleranced radial clearance permits axial sliding of the left ball bearing 69 relative to the midwall 657 without inducing excessive shaking, which shaking is not conducive to overall stability of the front differential 6.

If desired, a separate compressible gasket or wave spring 697 (shown only in FIGS. 6 and 13) can be used between the ring gear 623 and the inner race 698 of the right ball bearing 691, so the right ball bearing 691 can provide further axial play of the ring gear joinder 62 relative to the differential housing 65.

The preferred front differential 6 further includes a rotational speed detection system 8. The preferred rotational speed detection system 8 includes a right semi-axle gear sensor 81 and an outer ring sensor 82. The right semi-axle gear 642 includes a number of axle speed teeth 644 on its outer periphery. The right semi-axle gear sensor 81 magnetically senses each time one of the axle speed teeth 644 passes through its magnetic field to determine the rotational speed of the right semi-axle gear 642 (which equals the rotational speed of the right half shaft 133 and the rotational speed of the right front wheel 121). The outer ring 671 includes a number of ring speed teeth 677 on its outer periphery. The outer ring sensor 82 magnetically senses each time one of the ring speed teeth 677 passes through its magnetic field to determine the rotational speed of the outer ring 671 (which equals the rotational speed of the ring gear joinder 62). The rotational speed of the left semi-axle gear 641 (and the rotational speed of the left half shaft 133 and the rotational speed of the left front wheel 121) is equal to twice the ring gear speed minus the right semi-axle gear speed.

Using axle speed teeth 644 and ring speed teeth 677 which are internal to the front differential housing 65 prevents accumulation of impurities such as soil and dust from interfering with rotation speed detection. The number of axle speed teeth 644 is preferably in the range from 22 to 32, more preferably in the range from 24 to 30, and most preferably in the range from 25 to 28, thereby permitting high accuracy in detecting rotational speed of the right semi-axle gear 642. The number of ring speed teeth 677 is similar, i.e., preferably in the range from 22 to 32, more preferably in the range from 24 to 30, and most preferably in the range from 25 to 28, thereby permitting high accuracy in detecting rotational speed of the gear ring. Using the axle speed teeth 644 directly on the right semi-axle gear 642 and the ring speed teeth 677 directly on the outer ring 671 avoids any need to separately mount further parts for speed detection.

Both the right semi-axle gear sensor 81 and the outer ring sensor 82 are supported by the differential housing 65 without overly increasing the size of the differential housing 65. Specifically, the right-semi axle gear sensor 81 is at least partially arranged inside the ring gear accommodation chamber 656, and the outer ring sensor 82 is at least partially arranged inside the clutch accommodation chamber 655. For instance, from 25 to 40% of the radial length of the outer ring sensor 82 is preferably positioned inside the clutch accommodation chamber 655. The real-time sensing of rotational speeds is preferably used in order to analyze whether and how much axial force to place on the friction plates 673 of the clutch 67, and thereby set how much the differential function of the front differential 6 is allowed to slip or be locked.

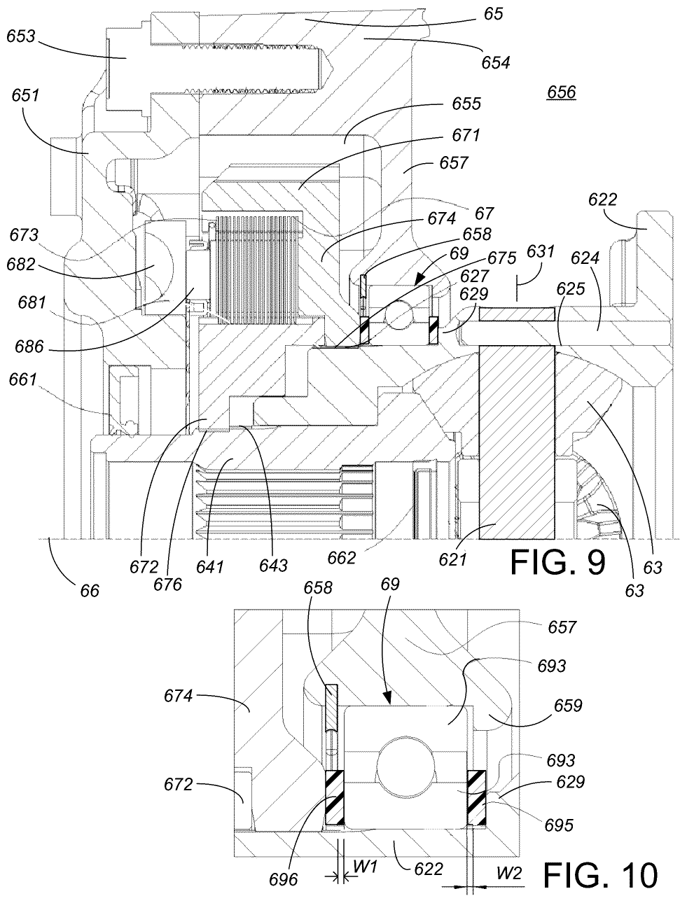

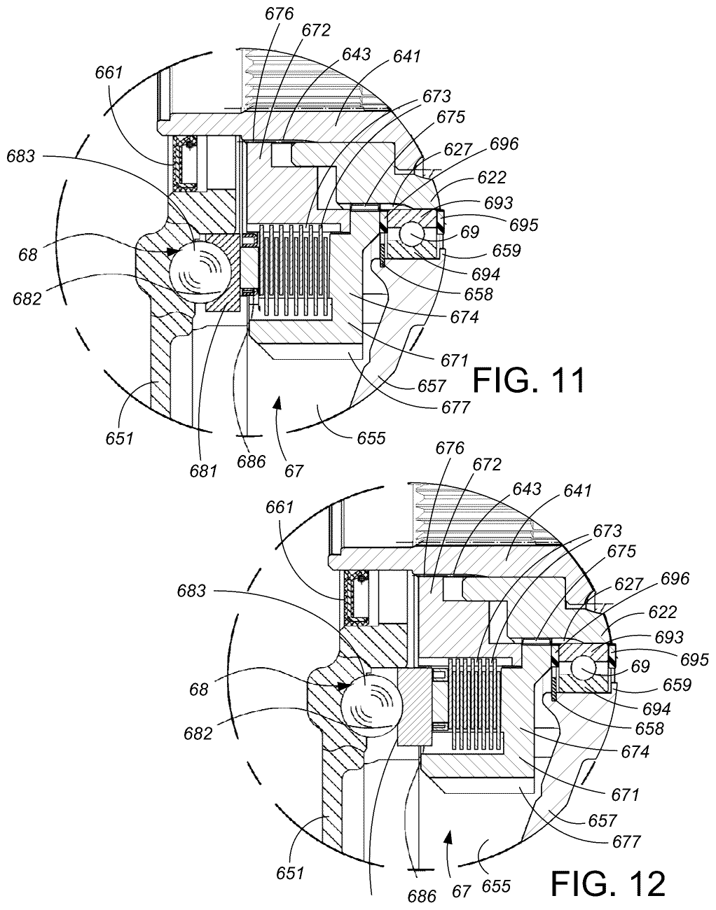

The preferred front differential 6 further includes several seal parts between elements with different rotational speeds. Specifically, left and right annular plug cover seals 661 are positioned to cover the interface between the respective left/right housing side wall 651/652 and the corresponding left/right semi-axle gear 641/642. The plug cover seals 661 prevent dust and particulate from entering the two chambers 655, 656. Lubricating oil (not shown) can be used so the semi-axle gears 64 can smoothly rotate relative to the ring gear joinder 62, and the plug cover seals 661 also prevent such lubricating oil from escaping from the front differential 6. Similarly, some embodiments use an inner housing with a continuous side wall (not shown), with a generous amount of lubricating oil (not shown) for the planetary gears 63. Encapsulation seals 662 (called out only in FIG. 9) may be used to prevent such lubricating oil for the planetary gears 63 from reaching lumens of the semi-axle gears 64. The plug cover seals 661 and the encapsulation seals 662 may be partially or entirely formed of rubber or rubber-like materials.

The all-terrain vehicle 100 of the present invention has particular utility in travelling on poor road surfaces such as muddy and slippery roads. The front differential 6 of the present invention allows full differential function while still adapting to minimize the likelihood of one front wheel 121 slipping with over-delivery of torque to the slipping wheel. The all-terrain vehicle 100 of the present invention is thus less likely to get stuck, while still having an elegant and low cost front differential assembly design.

Details of the foregoing description of preferred embodiments are not intended to limit the present invention. Various changes, modifications and improvements can be made by those skilled in the art while still using the spirit and principles of the present invention, all of which fall within the protection scope defined by the following claims.

1. An all-terrain vehicle comprising:
four wheels comprising a pair of front wheels and a pair of rear wheels;
a prime mover assembly for providing torque to move the vehicle; and
a drive train for delivering torque from the prime mover assembly to the wheels, the drive train comprising a drive shaft and a front differential, the front differential comprising:
a input bevel gear driven by the drive shaft;
a ring gear joinder comprising a ring gear and an inner housing fixedly connected to the ring gear, the ring gear being meshed with the input bevel gear so the ring gear joinder rotates about a differential transverse axis, the inner housing supporting at least one planetary gear shaft;
at least one planetary gear rotationally supported by the planetary gear shaft;
right and left semi-axle gears for driving the front wheels, the right and left semi-axle gears being meshed with the at least one planetary gear for rotation about the differential transverse axis;
a first ring supported for rotation with the ring gear joinder;
a second ring supported for rotation with one of the semi-axle gears;
a plurality of friction members disposed between the first ring and the second ring, wherein at least one of the friction members rotates with the first ring and at least one of the friction members rotates with the second ring;
wherein at least one of the first ring and the second ring is mounted in a way that allows axial movement relative to the ring gear joinder.

2. The all-terrain vehicle of claim 1, wherein the plurality of friction members are interleaved friction plates, wherein the front differential has a fully locked state caused by an axial pressure force placed on the interleaved friction plates in which the friction force causes both semi-axle gears and the ring gear joinder to rotate substantially synchronously, wherein the all-terrain vehicle further comprises a locking mechanism for applying the axial pressure force on the interleaved friction plates.

3. The all-terrain vehicle of claim 2, further comprising a rotational speed detection system, wherein the amount of axial pressure force provided by the locking mechanism is based upon values sensed by the rotational speed detection system.

4. The all-terrain vehicle of claim 3, wherein the rotational speed detection system senses rotational speed of the ring gear joinder and rotational speed of one of the semi-axle gears.

5. The all-terrain vehicle of claim 4, wherein the rotational speed detection system senses the rotational speed of the ring gear joinder in a range from 24 to 30 values per revolution and senses the rotational speed of one of the semi-axle gears in a range from 24 to 30 values per revolution.

6. The all-terrain vehicle of claim 2, wherein the first ring is an outer ring spline mounted on the inner housing so as to allow axial movement of the outer ring relative to the inner housing, and wherein the second ring is an inner ring spline mounted on the one of the semi-axle gears so as to allow axial movement of the inner ring relative to the one of the semi-axle gears.

7. The all-terrain vehicle of claim 2, wherein the front differential has a partial frictional state caused by a different amount of axial pressure force placed on the interleaved friction plates, where the left semi-axle gear and the right semi-axle gear can rotate at different rotational speeds but the interleaved friction plates create a frictional force tending to minimize an amount of rotational speed difference.

8. The all-terrain vehicle of claim 1, wherein the front differential further comprises:
a differential housing covering at least a portion of the front differential; and
a ball bearing arranged between the differential housing and the ring gear joinder for rotationally supporting the ring gear joinder relative to the differential housing, the ball bearing being connected to the differential housing by a clearance fit which allows the ball bearing to move axially relative to the differential housing.

9. The all-terrain vehicle of claim 8, wherein the ball bearing has an outer race in contact with the differential housing and an inner race in contact with the inner housing of the ring gear joinder, wherein the outer race has a clearance in the range from 0 mm to 0.04 mm relative to the differential housing.

10. The all-terrain vehicle of claim 8, wherein the front differential further comprises a second ball bearing disposed between the ring gear joinder and the differential housing so as to rotationally support the ring gear joinder.

11. The all-terrain vehicle of claim 8, wherein the differential housing comprises a midwall extending inwardly from a circumferential wall, and wherein the ball bearing is supported by the midwall.

12. The all-terrain vehicle of claim 11, wherein the plurality of friction members are interleaved friction plates of a clutch, and wherein the differential housing defines:
a clutch accommodation chamber with the interleaved friction plates disposed in the clutch accommodation chamber, and
a ring gear accommodation chamber with the ring gear disposed in the ring gear accommodation chamber.

13. The all-terrain vehicle of claim 1, wherein the front differential assembly comprises a drive shaft transfer case, the drive shaft transfer cases having an engaged position where torque is transmitted from the drive shaft to the input bevel gear and a disengaged position where torque is not transmitted from the drive shaft to the input bevel gear.

14. The all-terrain vehicle of claim 1, further comprising a straddle seat, with the prime mover assembly positioned under the straddle seat.

15. The all-terrain vehicle of claim 1, wherein the planetary gear shaft is secured to the inner housing by a connection pin extending through a connection pin hole in the inner housing and through the planetary gear shaft, wherein the connection pin is held in place by joining the ring gear to the inner housing.

16. An all-terrain vehicle comprising:
four wheels comprising a pair of front wheels and a pair of rear wheels;
a prime mover assembly for providing torque to move the vehicle; and
a drive train for delivering torque from the prime mover assembly to the wheels, the drive train comprising a drive shaft and a front differential, the front differential comprising:
a input bevel gear driven by the drive shaft;
a ring gear joinder comprising a ring gear and an inner housing fixedly connected to the ring gear, the ring gear being meshed with the input bevel gear so the ring gear joinder rotates about a differential transverse axis, the inner housing supporting at least one planetary gear shaft;
at least one planetary gear rotationally supported by the planetary gear shaft;
right and left semi-axle gears for driving the front wheels, the right and left semi-axle gears being meshed with the at least one planetary gear for rotation about the differential transverse axis;
a plurality of friction members, wherein at least one of the friction members rotates with the ring gear joinder and at least one of the friction members rotates with one of the semi-axle gears;
a differential housing covering at least a portion of the front differential; and
a ball bearing arranged between the differential housing and the ring gear joinder for rotationally supporting the ring gear joinder relative to the differential housing, the ball bearing being connected to the differential housing by a clearance fit which allows the ball bearing to move axially relative to the differential housing.

17. The all-terrain vehicle of claim 16,
wherein the plurality of friction members are interleaved friction plates of a clutch;
wherein the differential housing comprises a midwall extending inwardly from a circumferential wall, the midwall and the circumferential wall of the differential housing jointly defining:
a clutch accommodation chamber with the interleaved friction plates disposed in the clutch accommodation chamber, and
a ring gear accommodation chamber with the ring gear disposed in the ring gear accommodation chamber; and
wherein the ball bearing is supported by the midwall.

18. The all-terrain vehicle of claim 17, wherein the front differential has a fully locked state caused by an axial pressure force placed on the interleaved friction plates in which the friction force causes both semi-axle gears and the ring gear joinder to rotate substantially synchronously, wherein the all-terrain vehicle further comprises:
a locking mechanism for applying the axial pressure force on the interleaved friction plates; and
a rotational speed detection system sensing rotational speed of the ring gear joinder and rotational speed of one of the semi-axle gears, wherein the amount of axial pressure force provided by the locking mechanism is based upon values sensed by the rotational speed detection system.

19. The all-terrain vehicle of claim 18, wherein at least one of the interleaved friction plates is rotationally driven by a ring which is spline mounted so as to allow axial movement of the ring relative to the inner housing of the ring gear joinder.

20. An all-terrain vehicle comprising:
four wheels comprising a pair of front wheels and a pair of rear wheels;
a prime mover assembly for providing torque to move the vehicle;
a straddle seat positioned over the prime mover assembly; and
a drive train for delivering torque from the prime mover assembly to the wheels, the drive train comprising a drive shaft and a front differential, the front differential comprising:
a input bevel gear driven by the drive shaft;
a ring gear joinder comprising a ring gear and an inner housing fixedly connected to the ring gear, the ring gear being meshed with the input bevel gear so the ring gear joinder rotates about a differential transverse axis, the inner housing supporting at least one planetary gear shaft, wherein the planetary gear shaft is secured to the inner housing by a connection pin extending through a connection pin hole in the inner housing and through the planetary gear shaft, wherein the connection pin is held in place by joining the ring gear to the inner housing;
at least one planetary gear rotationally supported by the planetary gear shaft;
right and left semi-axle gears for driving the front wheels, the right and left semi-axle gears being meshed with the at least one planetary gear for rotation about the differential transverse axis;
a plurality of friction members, wherein at least one of the friction members rotates with the ring gear joinder and at least one of the friction members rotates with one of the semi-axle gears; and
a differential housing covering at least a portion of the front differential.
